(19) United States
(12) Patent Application Publication
(10) Pub. No.: US 2024/0229356 A1
(43) Pub. Date: Jul. 11, 2024

(54) SHOE PRESS ROLL COVER

(71) Applicant: Voith Patent GmbH, Heidenheim (DE)

(72) Inventors: Delphine Delmas, Heidenheim (DE); Uwe Matuschczyk, Geislingen (DE)

(21) Appl. No.: 18/616,943

(22) Filed: Mar. 26, 2024

Related U.S. Application Data
(63) Continuation of application No. PCT/EP2022/075333, filed on Sep. 13, 2022.

(30) Foreign Application Priority Data
Sep. 28, 2021 (DE) 10 2021 125 037.4

(51) Int. Cl. D21F 3/02; C08G 18/10; C08G 18/48

(52) U.S. Cl. CPC D21F 3/0236; C08G 18/10; C08G 18/4854

(57) ABSTRACT

A shoe press roll cover for a machine for producing and/or finishing a fibrous web, such as a paper, card or tissue web, is formed of a matrix material composed of polyurethane, formed essentially from 4,4′-MDI as isocyanate, at least one polyol and at least one crosslinker. The polyurethane matrix material is biobased to an extent of at least 20% by weight. The polyol and the crosslinker are selected from one of several combinations: a) biobased PTMEG as polyol and a mixture of MCDEA and PTMEG as crosslinker; b) polycarbonate as polyol and a mixture of MCDEA and biobased polycarbonate polyol as crosslinker; c) a mixture of biobased polycarbonate polyol and PTMEG as polyol and 1,4-BDO as crosslinker; d) PTMEG as polyol and a mixture of PTMEG and MCDEA as crosslinker, with the 4,4′-MDI in the isocyanate and the PTMEG in the polyol being biobased.

### CROSS-REFERENCE TO RELATED APPLICATION

This application is a continuation, under 35 U.S.C. § 120, of copending International Patent Application PCT/EP2022/075333, filed Sep. 13, 2022, which designated the United States; this application also claims the priority, under 35 U.S.C. § 119, of German Patent Application DE 10 2021 125 037.4, filed Sep. 28, 2021; the prior applications are herewith incorporated by reference in their entirety.

### FIELD AND BACKGROUND OF THE INVENTION

The invention relates to a shoe press roll cover for a machine for production and/or finishing of a fibrous material web, such as paper, cardboard or tissue web, comprising a matrix material composed of polyurethane formed essentially from 4,4′-MDI as isocyanate, at least one polyol and at least one crosslinker. The invention further relates to a shoe press having such a shoe press roll cover, and to a machine for production and/or finishing of a fibrous material web with such a shoe press.

Such a shoe press roll cover of the generic type is known, for example, from European published patent application EP2248944 A1.

The word “essentially” in this connection means that the polyurethane matrix material, aside from the starting materials mentioned, may also comprise small amounts of other materials, for example small amounts of catalysts for the or in the at least one crosslinker. However, these other materials account for less than 8% by weight of all starting materials, or more preferably for less than 5% by weight, and most preferably for less than 2% by weight.

Shoe presses find numerous uses in the paper industry. For example, it is possible to use shoe presses to transfer a tissue web from a press felt onto the surface of a Yankee cylinder. A shoe press is particularly notable for its extended press nip, which makes it possible to efficiently press the fibrous material web, but without exerting too high a peak pressure thereon, which otherwise impairs the thickness of the fibrous material web.

In order to be able to achieve the extended press nip, what is needed, in addition to a roller, is a shoe that can be pressed against the roller, the surface of which has concave curvature matched to the curvature of the roller. In operation as intended, a rotating shoe press roll cover is run over the shoe. This is a continuous hose that must be sufficiently flexible to be able to withstand the constant cyclical flexural stresses between concave and convex curvature as it revolves. The shoe press roll cover, in use as intended, is subject to extremely high stresses that lead to wear and hence necessitate regular exchange thereof.

The known shoe press roll covers consist predominantly of polyurethane, which forms a matrix material into which reinforcing filaments or the like are generally embedded. The amount of polyurethane consumed in this way is quite considerable. After they have been used, shoe press roll covers are generally utilized thermally, i.e. incinerated. This is nonoptimal for environmental reasons.

There is also a drive to further improve the known shoe press covers with regard to various properties of significance for the use as matrix material of a shoe press roll cover. In particular, these may be one or more of the following properties: tear resistance (tear widening), tear propagation resistance, tan delta, force at 10% elongation after hydrolysis, breaking stress, elongation at break, abrasion resistance, and increase in weight on storage in liquid media.

### SUMMARY OF THE INVENTION

It is therefore an object of the present invention to counteract the problem described above, and in particular to make a contribution to decarbonization. At the same time, the properties of relevance to the operation of a shoe press roll cover are not to be adversely affected, but preferably improved.

With the above and other objects in view there is provided, in accordance with the invention, a shoe press roll cover for a machine for processing a fibrous material web, the roll cover comprising:
a matrix material composed of polyurethane formed essentially from 4,4′-MDI as isocyanate, at least one polyol, and at least one crosslinker;
wherein the polyurethane matrix material is biobased to an extent of at least 20% by weight, and wherein the at least one polyol and the at least one crosslinker are selected from one of the below-listed combinations a) to d). The following acronyms appear in the text:
PTMEG—polytetrahydrofuran or polytetramethylene ether glycol;
MCDEA—4,4-methylene-bis(3-chloro-2,6-diethyl aniline;
1,4′-BDO—butanediol or butane-1,4-diol;
MDI, 4,4-MDI—methylene diphenyl diisocyanate.

Again in other words, the objects of the invention are achieved in that, in the shoe press roll cover of the generic type as described at the outset, the polyurethane matrix material is biobased to an extent of at least 20% by weight, where the at least one polyol and the at least one crosslinker are selected from one of the following combinations:
a) PTMEG as polyol and a mixture of MCDEA and PTMEG as crosslinker, where the PTMEG in the polyol and in the crosslinker is biobased;
b) polycarbonate as polyol and a mixture of MCDEA and polycarbonate polyol as crosslinker, where the polycarbonate polyol in the crosslinker is biobased;
c) a mixture of polycarbonate polyol and PTMEG as polyol and 1,4-BDO as crosslinker, where the polycarbonate polyol in the polyol is biobased;
d) PTMEG as polyol and a mixture of PTMEG and MCDEA as crosslinker, where the 4,4′-MDI in the isocyanate and the PTMEG in the polyol are biobased.

What is meant here by the term “biobased” is that the material has been produced not on a petroleum basis, but from renewable raw materials. The finished product of the invention is distinguishable from conventional shoe press covers since it is possible by the radiocarbon method to determine how many percent of the carbon present in the material is of the ¹⁴C isotope type. This carbon isotope is unstable in that it is subject to a radioactive decay process. It is therefore virtually no longer present in petroleum. It is thus possible, for example, by means of the standardized test method according to ASTM D6866, in a relatively simple manner, to determine the biobased fraction of carbon atoms relative to the total fraction of carbon atoms in a material.

Although the production of polyurethane from at least partly biobased starting materials is already known per se, this has not yet been considered specifically for shoe press roll covers. For example, in published international patent application WO 2021/074492A1 states that roll covers can be produced from recycled starting materials and optionally additionally from biobased starting materials. The inventors have found to their surprise that, on the basis of biobased starting materials for the polyurethane matrix, it is possible not just to produce shoe press roll covers with comparable or identical mechanical properties to those in the case of the conventional use of petroleum-based starting materials, but that the mechanical properties of the shoe press covers can even be improved at least for some specific compositions. The exact reason for this is not yet clear, but experiments in this regard have given clear results.

In this way, not only is it possible by virtue of the present invention to improve the CO₂ balance in the production of shoe press covers, since the CO₂ released in the incineration of the shoe press covers is at least partly absorbed again by plants that are then used for production of new shoe press roll covers, but the present invention additionally also offers the opportunity to positively influence the mechanical properties of the shoe press covers of the invention.

The polyurethane matrix material is preferably biobased to an extent of at least 50% by weight. It would even be conceivable to produce the shoe press cover entirely from biobased starting materials.

The 4,4′-MDI here, as isocyanate in the polyurethane matrix material, if it is not explicitly identified as biobased according to the present invention, may be petroleum-based.

It is also possible for the at least one polyol in the polyurethane matrix material, if it is not explicitly identified as biobased according to the present invention, to be petroleum-based.

In addition, it is also possible for the at least one crosslinker in the polyurethane matrix material, if it is not explicitly identified as biobased according to the present invention, to be petroleum-based.

It shall be assumed hereinafter that the starting materials which are not explicitly identified as biobased, shall be petroleum-based.

In the specific working example of a polyurethane matrix composition for a shoe press cover of the invention, the polyurethane of the polymer matrix is formed from: 4,4′-MDI as isocyanate, PTMEG as polyol and a mixture of MCDEA and PTMEG as crosslinker, where the PTMEG in the polyol and in the crosslinker is biobased. MCDEA stands for 4,4-methylenebis(3-chloro-2,6-diethylaniline).

This composition (last row in table 1A) is compared below with a corresponding composition composed of purely petroleum-based starting materials (penultimate row in table 1A).

TABLE 1A

| | |
|---|---|
| Prepolymer | Biobased |

| Isocyanate | Polyol | Crosslinker | content [%] |
|---|---|---|---|
| 4,4′-MDI | PTMEG | MCDEA, PTMEG | 0 |
| 4,4′-MDI | biobased | MCDEA, biobased | 61 |
| | PTMEG | PTMEG | |

Tests on corresponding cast samples showed that the polyurethane made from biobased starting materials (last row in table 1B) differs advantageously from the corresponding comparative material made from petroleum-based matrix material (penultimate row in table 1B) with regard to various properties of significance for use as matrix material of a shoe press roll cover.

TABLE 1B

| | Tear propagation | | | |
|---|---|---|---|---|
| Tear | resistance (DIN 53515) | | Tan delta | Tan delta |
| widening | Max. force | Integral under | 20° C. | 60° C. |
| [mm] | [N/mm] | curve (energy) | [—] | [—] |
| 0.6 | 58 | 2213 | 0.1 | 0.08 |
| 0 | 64 | 2817 | 0.08 | 0.06 |

The property “Tear widening [mm]” is the result of a test in which a standardized sample is notched and then subjected to one million flexing cycles at the notch site on a testbed. This is followed by a measurement of the extent to which the tear has increased in size at the notch site. The smaller this value, the better the suitability of the polyurethane as matrix material for a shoe press roll cover. In the first working example, it can be seen that the tear has not widened at all in the case of the biobased polyurethane, whereas it has increased in size by 0.6 mm in the case of the petroleum-based polyurethane.

The property “tear propagation resistance” is the result of a test described in standard DIN 53515, in which the force opposing tear propagation in a sample that has been damaged by cutting is determined. It is also possible here to determine the area (i.e. the integral) beneath the curve in the load-strain diagram, which corresponds to the energy. The greater the respective value, the better the suitability of the polyurethane as matrix material for a shoe press roll cover. In the first working example, it can be seen that, in the case of the sample made from biobased polyurethane, the values are above those of the comparative sample made from petroleum-based polyurethane.

The property “tan delta” in rheology is a loss factor that describes the ratio between loss modulus G″ (imaginary part) and storage modulus G′ real part), as tan delta=G″/G′. The higher the loss factor, the closer the approximation of the behavior of a sample to that of a liquid of ideal viscosity with newtonian flow characteristics. The lower the loss factor, the more the behavior of a sample corresponds to that of a solid of ideal elasticity. The latter is desirable for the matrix material for a shoe press roll cover. In the first working example, it can be seen that, in the case of biobased polyurethane, the values of tan delta both at 20° C. and at 60° C. are smaller than those for the corresponding petroleum-based polyurethane.

In a second specific working example of a polyurethane matrix composition for a shoe press cover of the invention, the polyurethane of the polymer matrix is formed from: 4,4′-MDI as isocyanate, polycarbonate as polyol, and a mixture of MCDEA and polycarbonate polyol as crosslinker, where the polycarbonate polyol in the crosslinker is biobased.

This composition (last row in table 2A) is compared hereinafter with a corresponding composition made from purely petroleum-based starting materials (penultimate row in table 2A).

TABLE 2A

| Prepolymer | | | Biobased |
|---|---|---|---|
| Isocyanate | Polyol | Crosslinker | content [%] |
| 4,4′-MDI | polycarbonate | MCDEA, polycarbonate | 0 |
| | | polyol | |
| 4,4′-MDI | polycarbonate | MCDEA, biobased | 25 |
| | | polycarbonate polyol | |

Tests on corresponding cast samples showed that the polyurethane made from biobased starting materials (last row in table 2B) differs advantageously from the corresponding comparative material made from petroleum-based matrix material (penultimate row in table 2B) with regard to various properties of significance for use as matrix material of a shoe press roll cover.

TABLE 2B

| tan | tan | | | Load at 10% | | Elon- |
|---|---|---|---|---|---|---|
| delta | delta | H₂O | H₂O₂ | strain after | Breaking | gation |
| 20° C. | 60° C. | swelling | swelling | hydrolysis | stress | at break |
| [−] | [−] | [%] | [%] | [%] | [N/mm²] | [%] |
| 0.12 | 0.08 | 1 | 1.8 | 68 | 39 | 352 |
| 0.09 | 0.07 | 0.9 | 0.7 | 73 | 42 | 427 |

In the second working example too, it is apparent that the tan delta values both at 20° C. and at 60° C. are lower and hence better in the case of the polyurethane sample with the biobased content than in the case of the corresponding comparative sample made from purely petroleum-based components.

The properties “H₂O swelling” and “H₂O₂ swelling” are the percentage increase in weight when the material is placed in water and in hydrogen peroxide respectively for a prolonged period of time. The lower the swelling, the better the suitability of the polyurethane as matrix material for a shoe press roll cover. In the second working example, it is apparent that, in the sample made of biobased polyurethane, the corresponding values are below those for the comparative sample made from petroleum-based polyurethane.

The property “Load at 10% strain after hydrolysis”, in the load-strain diagram, is the force required for elongation of a sample by 10% after the sample has been subjected to hydrolysis. More specifically, for example, the value of 73% means that, an elongation of 10% after hydrolysis requires only 73% of the force that was required before the hydrolysis. The greater the value, the better the suitability of the polyurethane as matrix material for a shoe press roll cover. In the second working example, it can be seen that the corresponding value for the sample made from biobased polyurethane is above that for the comparative sample made from petroleum-based polyurethane.

The properties “breaking stress” and “elongation at break” are results familiar to the person skilled in the art from standardized tensile tests. The greater these values, the better the suitability of the polyurethane as matrix material for a shoe press roll cover. In the second working example, it can be seen that the corresponding values for the sample made from biobased polyurethane are above those for the comparative sample made from petroleum-based polyurethane.

In a third specific working example of a polyurethane matrix composition for a shoe press roll cover of the invention, the polyurethane of the polymer matrix is formed from: 4,4′-MDI as isocyanate, a mixture of polycarbonate polyol and PTMEG as polyol and 1,4-BDO as crosslinker, where the polycarbonate polyol in the polyol is biobased. 1,4-BDO stands for 1,4-butanediol.

This composition (last row in table 3A) is compared hereinafter with a corresponding composition made from purely petroleum-based starting materials (penultimate row in table 3A).

TABLE 3A

| Prepolymer | | | Biobased |
|---|---|---|---|
| Isocyanate | Polyol | Crosslinker | content [%] |
| 4,4′-MDI | polycarbonate, PTMEG | 1,4-BDO | 0 |
| 4,4′-MDI | biobased | 1,4-BDO | 51 |
| | polycarbonate, PTMEG | | |

Tests on corresponding cast samples showed that the polyurethane made from biobased starting materials (last row in table 3B) differs advantageously from the corresponding comparative material made from petroleum-based matrix material (penultimate row in table 3B) with regard to various properties of significance for use as matrix material of a shoe press roll cover.

TABLE 3B

| | Tear propagation | | |
|---|---|---|---|
| Tear | resistance (DIN 53515) | Load at 10% | |
| widening | Integral under | strain after | H₂O₂ |
| [mm] | curve (energy) | hydrolysis [%] | swelling [%] |
| 0.1 | 3986 | 73 | 1.6 |
| 0.2 | 4679 | 85 | 0.4 |

In a third working example, it can be seen that the value for the H₂O₂ swelling is below that for the comparative sample made from petroleum-based polyurethane, whereas all the other values are above the corresponding values for the comparative sample. Apart from tear widening, the sample made from biobased polyurethane is thus of better suitability than the comparative sample for use as matrix material for a shoe press roll cover.

In a fourth specific working example of a polyurethane matrix

composition for a shoe press cover of the invention, the polyurethane of the polymer matrix is formed from: 4,4′-MDI as isocyanate, PTMEG as polyol and a mixture of PTMEG and MCDEA as crosslinker, where the 4,4′-MDI in the isocyanate and the PTMEG in the polyol are biobased.

This composition (last row in table 4A) is compared hereinafter with a corresponding composition made from purely petroleum-based starting materials (penultimate row in table 4A).

TABLE 4A

| | |
|---|---|
| Prepolymer | Biobased |

| Isocyanate | Polyol | Crosslinker | content [%] |
|---|---|---|---|
| 4,4′-MDI | PTMEG | PTMEG, MCDEA | 0 |
| biobased | biobased | PTMEG, MCDEA | 76 |
| 4,4′-MDI | PTMEG | | |

Tests on corresponding cast samples showed that the polyurethane

made from biobased starting materials (last row in table 4B) differs advantageously from the corresponding comparative material made from petroleum-based matrix material (penultimate row in table 4B) with regard to various properties of significance for use as matrix material of a shoe press roll cover.

TABLE 4B

| | | | | | | Increase in |
|---|---|---|---|---|---|---|
| Breaking | Increase | Increase | tan delta | tan delta | Abrasion | abrasion value |
| stress | in weight | in weight | 20° C. | 60° C. | value | after hydrolysis |
| [N/mm²] | H₂O₂ [%] | H₂O [%] | [−] | [−] | [mm³] | [%] |
| 37 | 5.3 | 1.5 | 0.1 | 0.08 | 32 | 240 |
| 42 | 3.9 | 1.4 | 0.08 | 0.06 | 46 | 81 |

In the fourth working example, it is apparent that the value for breaking stress in the case of the sample made from biobased polyurethane is above that for the comparative sample made from petroleum-based polyurethane, whereas the values for increase in weight H₂O₂, for increase in weight H₂O and for tan delta at 20° C. and 60° C. are below the corresponding values for the comparative sample. The sample made from biobased polyurethane is thus of better suitability than the comparative sample for use as matrix material for a shoe press roll cover with regard to all these values.

The property “abrasion value” is the result of a test in order to determine the extent of abrasion that the sample material undergoes under standardized conditions. The smaller this value, the better the suitability of the polyurethane as matrix material for a shoe press roll cover. In the fourth working example, it can be seen that the abrasion value for the sample made from biobased polyurethane is above the value for the comparative sample made from petroleum-based polyurethane, but this value increases to a much lesser degree in percentage terms after hydrolysis than in the case of the comparative sample, which is positive.

Further aspects of the present invention relates to a machine for production and/or finishing of a fibrous material web, such as paper, cardboard or tissue web, comprising an above-described shoe press roll cover of the invention, and to a machine for production and/or finishing of a fibrous material web, such as paper, cardboard or tissue web, comprising such a shoe press.

1. A shoe press roll cover for a machine for processing a fibrous material web, the roll cover comprising:
a matrix material composed of polyurethane formed essentially from 4,4′-MDI as isocyanate, at least one polyol, and at least one crosslinker;
said polyurethane matrix material being biobased to an extent of at least 20% by weight, and wherein said at least one polyol and said at least one crosslinker are selected from one of the following combinations:
a) PTMEG as polyol and a mixture of MCDEA and PTMEG as crosslinker, where the PTMEG in the polyol and in the crosslinker is biobased;
b) polycarbonate as polyol and a mixture of MCDEA and polycarbonate polyol as crosslinker, where the polycarbonate polyol in the crosslinker is biobased;
c) a mixture of polycarbonate polyol and PTMEG as polyol and 1,4-BDO as crosslinker, where the polycarbonate polyol in the polyol is biobased;
d) PTMEG as polyol and a mixture of PTMEG and MCDEA as crosslinker, where the 4,4′-MDI in the isocyanate and the PTMEG in the polyol are biobased.

2. The shoe press roll cover according to claim 1 configured for a machine for processing a paper web, a cardboard web, or a tissue web.

3. The shoe press roll cover according to claim 1, wherein said polyurethane matrix material is biobased to an extent of at least 50% by weight.

4. The shoe press roll cover according to claim 1, wherein said 4,4′-MDI as isocyanate in said polyurethane matrix material, where not identified as being biobased, is petroleum-biobased.

5. The shoe press roll cover according to claim 1, wherein said at least one polyol in said polyurethane matrix material, wherein not identified as being biobased, is petroleum-based.

6. The shoe press roll cover according to claim 1, wherein said at least one crosslinker in said polyurethane matrix material, where not identified as being biobased, is petroleum-based.

7. A shoe press for a machine for processing a fibrous material web, the shoe press comprising a shoe press roll cover according to claim 1.

8. The shoe press according to claim 7 configured for processing a paper web, a cardboard web, or a tissue web.

9. A machine for producing and/or finishing a fibrous material web, the machine comprising a shoe press according to claim 7.

10. The machine according to claim 9 configured for processing a paper web, a cardboard web, or a tissue web.
